(19) United States
(12) Patent Application Publication
(10) Pub. No.: US 2013/0066522 A1
(43) Pub. Date: Mar. 14, 2013

(54) STEERING SUPPORT SYSTEM FOR A TWO-WHEELER AS WELL AS A CONTROL FOR SUCH A STEERING SUPPORT SYSTEM

(71) Applicants: Hardy HAAS, Ditzingen-Schoeckingen (DE); Markus Lemejda, Ludwigsburg (DE); Peter Ziegler, Grossbottwar (DE)

(72) Inventors: Hardy HAAS, Ditzingen-Schoeckingen (DE); Markus Lemejda, Ludwigsburg (DE); Peter Ziegler, Grossbottwar (DE)

(21) Appl. No.: 13/604,345

(22) Filed: Sep. 5, 2012

(30) Foreign Application Priority Data
Sep. 9, 2011 (DE) 10 2011 082 413.8

(51) Int. Cl. B62D 6/06

(52) U.S. Cl. 701/41; 180/400; 180/421; 180/446

(57) ABSTRACT

A control for a steering support system for a two-wheeled vehicle is provided. The steering support system has an actuator with the aid of which a steering torque is applied to the two-wheeled vehicle. The actuator is, for example, an electric motor which cooperates with a steering tube. The control triggers the actuator in a targeted manner to effect a desired steering torque. Furthermore, various sensors are provided for detecting vehicle dynamics parameters, such as a steering angle, a steering torque, accelerations acting on the two-wheeled vehicle, or speeds of wheels of the two-wheeled vehicle. Based on the parameters detected by the sensors, the actuator may be triggered to effect a steering torque.

### BACKGROUND OF THE INVENTION

1. Field of the Invention

The present invention relates to a steering support system for a two-wheeler, in particular a motorcycle, as well as a control for such a steering support system.

2. Description of the Related Art

Two-wheelers and motorcycles in particular are traditionally steered only by the forces exerted by the driver. In the case of motorcycles in particular, which are designed for straight-line stability at high speeds, high steering forces are required in tight curves, for example. This is due mainly to the fact that the so-called castor angle or control head angle should be large for a high driving stability, which results in the fact that the steering torques required for steering the motorcycle are high. For example, high steering forces are required in maneuvers at very low speeds. Even during sharp braking in curves with a highly inclined position, great steering forces are required to maintain the curve radius.

There are known steering dampers for motorcycles, which are to suppress undesirable rapid steering movements with a fixed damping rate in particular, to reduce the risk of a handlebar “kick back.” One example of such a damping device is provided in published German patent application document DE 10 2007 049 353 A1. However, the use of such steering dampers may lead to a further increase in steering forces having to be applied in particular in tight curves or in steering maneuvers. This may make handling of the motorcycle much more difficult and decrease the driver's comfort.

### BRIEF SUMMARY OF THE INVENTION

The present invention relates to a steering support system, with the aid of which steering forces to be applied by the driver may be supported automatically for steering a two-wheeler or may be adapted to certain driving situations. In particular, both driving comfort and safety in driving a two-wheeler may be increased through the steering support system.

A steering support system according to the present invention has an actuator for applying a steering torque to the two-wheeler, a control for controlling the steering torque induced by the actuator and at least one sensor for detecting the vehicle dynamics parameters of the two-wheeler.

Ideas concerning the present invention are based on the following findings: It has been assumed in the past that the steering forces exerted by the driver are sufficient for steering two-wheelers, and no additional forces for supporting steering operations are necessary or desirable. It has now been recognized that a steering support could be helpful in particular in certain driving situations even with two-wheelers. In particular, it has been recognized that an automated steering support system, which may exert steering torques on the two-wheeler in certain driving situations, may be advantageous. It has thus been recognized as advantageous to adapt a steering support system resembling power steering systems, such as those known from the field of passenger vehicles, to meet the needs of two-wheelers.

The steering support system for motorcycles may be triggered in such a way that comfort for the driver is increased on the one hand in that, for example, the steering forces to be applied by the driver during maneuvers or during negotiating tight curves may remain low because of the additional steering forces applied by the system. On the other hand, with the aid of the steering support system described here, in driving situations which are critical for the driver, an additional steering torque may be automatically generated and superimposed on the steering torque exerted by the driver, whereby critical situations may be alleviated for the driver.

Furthermore, it has been recognized that in motorcycles whose steering is equipped with passive steering dampers, the steering damping thereby achieved is undesirable in rapid steering in alternating curves and during maneuvers, for example, and is often too weak in the event of kick back. Both situations could be optimally covered by a situation-dependent superimposition of a steering torque applied by a steering support system in a method.

The actuator for applying the steering torque to the two-wheeler may be, for example, an electric motor, which is designed in such a way that it may interact with the two-wheeler's steering. Alternatively, the actuator may also be designed as a hydraulic system, which may apply the forces to the steering of the two-wheeler. The electric motor and the hydraulic system may, possibly via an appropriate gear mechanism, be situated on a steering tube or a control head bearing and may interact with it, so that an adjustable torque may be applied to the handlebars of the two-wheeler in both directions when the electric motor is energized, for example.

With respect to the torque to be applied and the duration of application of such a torque, the electric motor and the hydraulic system may be designed to generate a slow application of force over a significant steering angle range on the two-wheeler and its steering, to support, for example, as in a power steering system, a steering intent on the part of the driver to also generate short abrupt steering torques to support the vehicle situation-dependent in extreme critical driving situations similar to an ESP system (electronic stabilization program).

The at least one sensor provided in the steering support system may be designed to detect an instantaneous steering angle, a steering torque instantaneously being applied by a driver and/or an acceleration instantaneously acting on the two-wheeler.

Suitable position sensors, force sensors and/or acceleration sensors may be provided on the steering of the two-wheeler for this purpose. The position sensors may, for example, detect information about the instantaneous position of a steering tube in relation to a chassis of the two-wheeler and therefore information about an instantaneous steering angle. The force sensors may measure, for example, the force exerted by a driver via the handlebars and thus provide information about the steering torque instantaneously being applied. The acceleration sensors may provide information about an instantaneous acceleration of the entire two-wheeler or only about certain components of the two-wheeler, for example. Yaw rate sensors, roll rate sensors or acceleration sensors, for example, may be used to detect transverse accelerations, longitudinal accelerations and/or vertical accelerations.

Additionally, other sensors may also be used for detecting other vehicle dynamics parameters, such as the instantaneous speed of the two-wheeler, instantaneous control signals from an antilock brake system, etc. Furthermore, it may be advantageous to be able to determine a steering torque instantaneously being applied by the actuator, for example, by ascertaining the electrical current applied to the actuator.

The control of the steering support system, which may be implemented in a control unit, for example, may be designed to receive signals from the at least one sensor and to trigger the actuator for applying a steering torque to the two-wheeler based on these signals.

The control may intervene in a situation-specific manner and as a function of the vehicle dynamics parameters of the two-wheeler, which are detected by the sensor, in a steering maneuver of the two-wheeler, in that additional steering torques applied by the actuator are superimposed on the steering forces applied by the driver. A total steering torque M_{L}_{_{—}}_{gee} may be made up additively of steering torque M_{L}_{_{—}}_{driver} applied by the driver and a steering torque M_{L}_{_{—}}_{EPS} applied by the actuator functioning as a power steering (electric power steering, EPS) M_{L}_{_{—}}_{ges}=M_{L}_{_{—}}_{driver}+M_{L}_{_{—}}_{EPS}. Additional steering torque M_{L}_{_{—}}_{EPS} applied by the actuator may differ with regard to sign from the sign of steering torque M_{L}_{_{—}}_{driver} applied by the driver.

The control may be designed to detect the driver's steering intent on the basis of the signals supplied by the sensors and then to trigger the actuator in such a way that a steering torque supporting the steering intent is generated by the actuator. In this operating mode of the control, the steering support system may act as a power steering. The driver's steering intent may be ascertained by a sensor for measuring the driver's steering torque, for example.

Alternatively, the control may be designed to estimate, on the basis of the signals supplied by the sensors, an interfering steering torque such as that which occurs when braking while negotiating a curve and to trigger the actuator in such a way that a steering torque counteracting the interfering steering torque is generated by the actuator. It is thus possible to actively counteract the interfering steering torque, which occurs undesirably when braking a two-wheeler during negotiating a curve at a highly inclined position, and which may cause the two-wheeler to straighten up. Potentially critical driving situations may be alleviated in this way.

Alternatively or additionally, the control may be designed to estimate, on the basis of control signals of an antilock brake system, an interfering steering torque to be expected when braking while negotiating a curve and to trigger the actuator in such a way that a steering torque counteracting the interfering steering torque is generated by the actuator. In other words, the control signals effected by the antilock brake system during sharp braking, on the basis of which the braking operation and in particular the forces effected by the brakes are controlled, may be used to estimate an interfering steering torque to be expected prior to the occurrence of the actual interfering steering torques and to trigger the actuator already in advance to take corresponding counter-steering measures.

In another specific embodiment, the control is designed to detect, based on the signals, oscillations in a yaw rate and/or a roll rate of the two-wheeler and to trigger the actuator to take corresponding counter-steering measures.

Since oscillations in the yaw rate and/or the roll rate are a typical sign of the occurrence of the so-called high-speed oscillation of a motorcycle, such a high-speed oscillation may be counteracted by active counter-steering and the vehicle dynamics of the motorcycle may be improved.

As an additional specific embodiment, the control may be designed to detect a kick back of the two-wheeler on the basis of signals from the sensors and to trigger the actuator to a corresponding countermeasure. In this embodiment, the steering support system may function like a steering damper and counteract rapid steering movements.

In another specific embodiment, the control may detect tilting tendencies of the two-wheeler at a low speed on the basis of the signals of the sensors and may counter such tilting tendencies by a counteracting steering torque by targeted triggering of the actuator. In this way, a mechanism for automated equilibration may be set aside for a driver, in particular at low speeds, at which gyroscopic forces of the motorcycle are not enough to stabilize the motorcycle.

In another alternative specific embodiment, the control may detect an oversteer of the two-wheeler based on the sensor signals and may trigger the actuator accordingly to generate a counteracting steering torque against such an oversteer.

The specific embodiments of the present invention described herein are aimed at least partially at applying the principles of an electrical power steering to two-wheelers, in particular motorcycles, to provide situation-dependent triggering of the power steering in the sense of torque superimposition.

It is pointed out that possible features and advantages of specific embodiments of the present invention are described herein partially with reference to a steering support system and partially with reference to a control or a control unit for such a steering support system. Those skilled in the art will recognize that the various features may be combined in any way and in particular may be transferred from the steering support system to the control and vice versa, to thereby arrive at additional embodiments of the present invention and possibly at synergistic effects.

### BRIEF DESCRIPTION OF THE DRAWING

FIG. 1 shows a motorcycle having a steering support system according to one specific embodiment of the present invention.

### DETAILED DESCRIPTION OF THE INVENTION

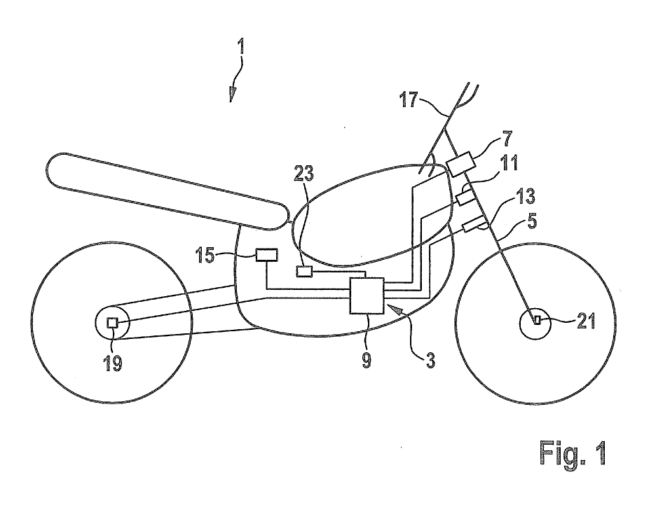

FIG. 1 shows a motorcycle 1 having a steering support system 3; the drawing is only schematic and is not drawn true to scale. The steering support system has several components. An actuator 7 mounted on a steering tube 5 is able to exert a torque on steering tube 5 with the aid of an electric motor or a hydraulic system and to thus exert a steering torque on the motorcycle. Actuator 7 is designed to apply both brief intense steering torques and gradual and steadily acting steering torques. To compensate for the complete steering torques, for example, which occur, for example, at full brake application in a curve, torques up to 70 Nm may be necessary. This peak value may then decline continuously over the duration of the braking due to the straightening-up of the motorcycle during braking and a steering torque by the driver. Full braking from 100 km/h to a standstill takes approximately 3 s.

Actuator 7 is triggered by a control 9. Control 9 is connected to a plurality of sensors. For example, a steering angle sensor 11, a steering torque sensor 13 and an inertial sensor system 15 are shown here. Steering angle sensor 11 reports an instantaneous value of the steering angle and thus provides information about how sharply the steering of the motorcycle and how strongly the steering tube are deflected out of a position aligned for driving straight ahead. Steering torque sensor 13 supplies information about the force or torque with which a driver impresses the steering in the steering direction via handlebars 17. Inertial sensor system 15 may have multiple individual sensors or a sensor combination for measuring accelerations in a longitudinal direction, a vertical direction and/or a transverse direction and supplying the corresponding signals to control 9. Furthermore, speed sensors 19, 21 may measure the instantaneous speed of the motorcycle or the rotational rate of individual wheels and forward the corresponding signals to control 9.

Based on the signals generated by the sensors, which provide information about the vehicle dynamics parameters of the two-wheeler, control 9 may generate various triggering signals for actuator 7. Following such triggering signals, actuator 7 may generate a steering torque M_{L}_{_{—}}_{EPS} , which may be superimposed on steering torque M_{L}_{_{—}}_{driver}, which is generated by the driver.

For example, steering torque M_{L}_{_{—}}_{driver} of the driver may be supplemented and thus reinforced by steering torque M_{L}_{_{—}}_{EPS} generated by the actuator. At low and moderate speeds, for example, below 50 km/h, a reduction in the curve steering torque to be applied by the driver and thus an improvement in the subjective agility of the motorcycle may be achieved in this way.

To support the straight-line stability of the motorcycle, the castor angle of the motorcycle may be selected to be relatively large. The steering torque effected by the actuator should then approach 0 at high speeds. Such a reinforcement of the driver's steering torque may thus at the same time increase the comfort for the driver, similar to a power steering, while at the same time also bringing increased safety by permitting a larger castor angle and, associated with this, increased straight-line stability at high speeds.

In the case of braking while negotiating a curve at a highly inclined position, a counter torque M_{L}_{_{—}}_{EPS} may be generated through targeted triggering of actuator 7, which counteracts interfering torque M_{L}_{_{—}}_{stör} caused due to braking while negotiating a curve. In this case, an approximate interfering steering torque M_{L}_{_{—}}_{stör} may also be calculated from the measured or estimated wheel pressures on the front and rear wheels, the measured or estimated inclined position angle and the tire and vehicle geometry. This interfering steering torque may be multiplied by a factor k between 0 and 1 and then applied with a negative sign by actuator 7. On the whole, the influence of the interfering steering torque on the total steering torque is thereby reduced as follows:

M_{L}_{_{—}}ₜₒₜ=M_{L}_{_{—}}_{driver}+M_{L}_{_{—}}_{EPS}+M_{L}_{_{—}}_{Stör}=M_{L}_{_{—}}_{driver}+(1−k)×M_{L}_{_{—}}_{Stör}.

The reduced influence of the interfering steering torque may yield a substantial gain in safety when braking while negotiating a curve.

For the case when motorcycle 1 also has an antilock brake system electronic system 23, the setpoint pressure determined by ABS electronic system 23 may be used to calculate the interfering steering torque instead of the measured or estimated actual pressure in the brake system. This may be advantageous in particular to take into account the high dynamics, i.e., the rapid changes, in wheel pressures, such as those occurring in the case of sharp ABS-regulated braking, so that actuator 7 is able to equalize the interfering steering torque quickly enough.

In another application example, a counter torque, which may be applied by actuator 7, may be superimposed on the total steering torque for the case when there is a high-speed oscillation of the motorcycle. The high-speed oscillation may be recognized on the basis of oscillations in the yaw rate and/or in the roll rate of the motorcycle, and the counter torque should be utilized to allow such oscillations to die down quickly. The yaw rate signal and/or the roll rate signal may be used to determine the frequency and amplitude of the present oscillation, and a counter torque with which the oscillation may be optimally damped and which is to be applied by the actuator may be calculated from this.

In another embodiment, the steering support system may function as a steering damper. If by analyzing sensor signals, in particular steering angle signals, it is detected that a so-called kick back occurs at a higher speed, then a corresponding counter-steering torque may be applied by the steering support system via the actuator, in such a way that the oscillation of the kick back is damped. A steering torque which counteracts rapid steering movements is applied advantageously, essentially at a higher speed.

In another embodiment, the steering support system may be designed to contribute toward keeping the motorcycle in equilibrium at low speeds at which the gyroscopic forces of the motorcycle do not yet stabilize and balance it.

As another application example, the steering support system may be designed to counteract an oversteer of the motorcycle by targeted triggering of the actuator.

What is claimed is:

1. A steering support system for a two-wheeled vehicle, comprising:
an actuator for applying a steering torque to the two-wheeled vehicle;
a controller for controlling the steering torque applied by the actuator; and
at least one sensor for detecting vehicle dynamics parameters of the two-wheeled vehicle.

2. The steering support system as recited in claim 1, wherein the actuator is at least one of an electric motor and a hydraulic system for cooperating with a steering of the two-wheeled vehicle.

3. The steering support system as recited in claim 2, wherein the at least one sensor is configured to detect at least one of (i) an instantaneous steering angle, (ii) a steering torque instantaneously applied by a driver, (iii) an acceleration instantaneously acting on the two-wheeled vehicle, and (iv) an instantaneous speed of the two-wheeled vehicle.

4. A control for a steering support system for a two-wheeled vehicle, the steering support system including an actuator for applying a steering torque to the two-wheeled vehicle, and at least one sensor for detecting vehicle dynamics parameters of the two-wheeled vehicle, the control comprising:
a receiving unit configured to receive output signals from the sensor; and
a triggering unit configured to trigger the actuator, based on the output signals from the sensor, to apply a steering torque to the two-wheeled vehicle.

5. The control as recited in claim 4, wherein the control is configured to (i) detect a driver's steering intent based on the output signals from the sensor, and (ii) trigger the actuator in such a way that a steering torque corresponding to the steering intent is generated by the actuator.

6. The control as recited in claim 4, wherein the control is configured to (i) estimate, based on the output signals from the sensor, an interfering steering torque which occurs when braking while negotiating a curve, and (ii) trigger the actuator in such a way that a steering torque which counteracts the interfering steering torque is generated by the actuator.

7. The control as recited in claim 4, wherein the control configured to (i) estimate, based on control signals of an antilock brake system, an interfering steering torque to be expected when braking while negotiating a curve, and (ii) trigger the actuator in such a way that a steering torque which counteracts the interfering steering torque is generated by the actuator.

8. The control as recited in claim 4, wherein the control is configured to (i) detect, based on the output signals from the sensor, oscillations in at least one of a yaw rate and a roll rate of the two-wheeled vehicle, and (ii) trigger the actuator in such a way that a steering torque which counteracts the oscillations is generated by the actuator.

9. The control as recited in claim 4, wherein the control is configured to (i) detect, based on the output signals from the sensor, a kick-back of the two-wheeled vehicle, and (ii) trigger the actuator in such a way that a steering torque which counteracts the kick-back is generated by the actuator.

10. The control as recited in claim 4, wherein the control is configured to (i) detect, based on the output signals from the sensor, tilting tendencies of the two-wheeled vehicle at a low speed, and (ii) trigger the actuator in such a way that a steering torque which counteracts the tilting tendencies is generated by the actuator.

11. The control as recited in claim 4, wherein the control is configured to (i) detect, based on the output signals from the sensor, an over-steer of the two-wheeled vehicle, and (ii) trigger the actuator in such a way that a steering torque which counteracts the over-steer is generated by the actuator.
